(19) United States
(12) Patent Application Publication
(10) Pub. No.: US 2015/0087237 A1
(43) Pub. Date: Mar. 26, 2015

(54) INTERFERENCE MITIGATION AND SIGNAL ENHANCEMENT IN A WIRELESS COMMUNICATION SYSTEM

(71) Applicant: ALCATEL-LUCENT USA INC., Murray Hill, NJ (US)

(72) Inventor: Xiaohu Shang, Keyport, NJ (US)

(73) Assignee: ALCATEL-LUCENT USA INC., Murray Hill, NJ (US)

(21) Appl. No.: 14/037,897

(22) Filed: Sep. 26, 2013

(51) Int. Cl. H04B 1/10

(52) U.S. Cl. CPC H04B 1/1027
USPC 455/63.1

(57) ABSTRACT

Interference caused by signals transmitted by a wireless communication system can be mitigated at unintended receivers and enhanced at intended receivers. The interference created at one or more unintended receivers by a first signal transmitted from a transmitter to an intended receiver and the unintended receivers is mitigated by removing portions of a second signal that are uncorrelated with the first signal. The second signal is directed towards the unintended receivers. A third signal is enhanced at the intended receiver by allocating a portion of a transmission power associated with the removed portions of the second signal to the third signal.

### BACKGROUND

1. Field of the Disclosure

The present disclosure relates generally to communication systems and, more particularly, to wireless communication systems.

2. Description of the Related Art

A wireless communication system may be thought of as an interference network made up of pairs of transmitters and receivers. For example, a wireless communication system that includes a first base station that communicates with first user equipment over an uplink and a downlink and a second base station that communicates with second user equipment over an uplink and a downlink forms a wireless interference network. The wireless interference network includes a transmitter at the first base station paired with a receiver at the first user equipment, a receiver at the first base station transmitter paired with a transmitter at the first user equipment, a transmitter at the second base station paired with a receiver at the second user equipment, and a receiver at the second base station paired with a transmitter at the second user equipment. A signal transmitted from one transmitter to its intended receiver is seen as interference by unintended receivers in the other transceiver pairs. For example, downlink signals transmitted by the first base station are seen as interference by the receiver at the second user equipment. Mutual interference between the transceiver pairs can limit the performance of the wireless interference network.

The performance of the wireless interference network is evaluated based on the transmission rates of all the transceiver pairs. For example, the total sum rate or throughput of the transmissions of the transceiver pairs may be used as a performance metric or the individual rates for each transceiver pair could be used. In either case, the problem of optimizing the throughput in a wireless interference network is non-convex and therefore computationally intractable. Instead of solving the full non-convex problem, transmitters may apply a precoding matrix to the signal so that the transmitted signal generates zero interference at unintended receivers. This solution is known as the zero-forcing method.

Zero-forcing is not optimal and its performance is poor when the interference is weak, e.g., relative to noise, because zero-forcing sacrifices spatial degrees of freedom to avoid interference. The interference in the wireless interference network is relatively weak when the distance between a transmitter and its intended receiver is much smaller than the distance between the transmitter and the unintended receivers in other transceiver pairs. The interference in the wireless interference network may also be relatively weak when the transmitter has a relatively low power budget. Furthermore, zero-forcing is not effective if the number of antennas at the transmitter is smaller than the sum of the number of antennas at all other receivers in the wireless interference network. The number of antennas tᵢ for transmitter i must therefore satisfy:

$${t}_{i} > {\sum }_{j = 1 , j \neq i}^{K} {r}_{j}$$

Otherwise, the performance of the zero-forcing method is poor.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a wireless communication system according to some embodiments.

FIG. 2 is a flow diagram of a method for performing interference mitigation and signal enhancement according to some embodiments.

FIG. 3 is a plot that illustrates the improvement in the average sum rate that can be achieved by interference mitigation and signal enhancement according to some embodiments.

### DETAILED DESCRIPTION

The interference caused at unintended receivers in a wireless interference network by a signal transmitted from a transmitter can be mitigated, and the desired signal enhanced at its intended receiver, using redundant transmitting antennas that are present when the number of transmitting antennas at the transmitter is larger than the number of receiving antennas at the intended receiver. This approach can achieve a much larger sum rate (or set of individual rates) than the zero-forcing method because it uses all the available spatial degrees of freedom. For example, a first group of virtual antennas (equal in number to the number of antennas at the intended receiver) may be used to transmit a first signal from the transmitter to the intended and unintended receivers in the wireless interference network. A second group of virtual antennas (equal in number to the number of redundant antennas) can transmit a second signal, which is correlated with the first signal, to only the unintended receivers. The interference at the unintended receivers is reduced by removing the portion of the second signal that is uncorrelated with the first signal. Some of the transmission power from the uncorrelated portion of the second signal may then be used to enhance the desired signal at the intended receiver, e.g., using a water filling solution to allocate the transmission power from the uncorrelated portion of the second signal to a subset of virtual antennas. The process may be iterated until a convergence criterion is satisfied.

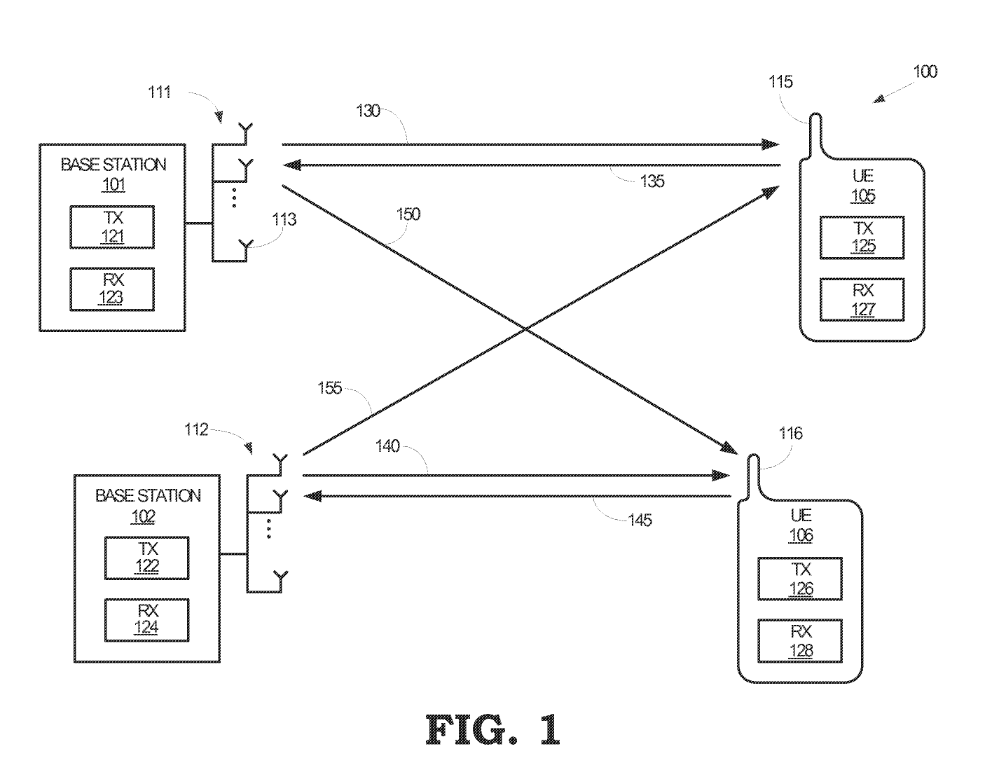

FIG. 1 is a block diagram of a wireless communication system 100 according to some embodiments. The wireless communication system 100 includes base stations 101, 102 for providing wireless connectivity to user equipment 105, 106. In the interest of clarity, two base stations 101, 102 and two user equipment 105, 106 are shown in FIG. 1. However, some embodiments may include different numbers of base stations or user equipment. As used herein, the term “base station” is used to indicate a device that is capable of providing wireless connectivity within a geographic area, cell, or sector. The term “base station” is therefore understood to encompass devices such as macrocells, access points, access networks, base station routers, home base station routers, microcells, femtocells, picocells, and the like. As used herein, the term “user equipment” is used to indicate devices that allow users to access the wireless communication system 100 over an air interface. The term “user equipment” is therefore understood to encompass relatively mobile devices such as smart phones, tablets, and laptops, as well as less mobile devices such as desktop computers, smart TVs, and the like.

The base stations 101, 102 are coupled to corresponding antenna arrays 111, 112 that include a plurality of individual antennas 113 (only one indicated by a distinguishing reference numeral in the interest of clarity). The number of antennas 113 in the antenna arrays 111, 112 is a matter of design choice. Moreover, the antennas 113 in the antenna arrays 111, 112 may be deployed in different configurations such as linearly polarized, cross polarized, circular polarized, and the like. User equipment 105, 106 include corresponding antennas 115, 116. Some embodiments of the user equipment 105, 106 may include a single antenna 115, 116 or they may include multiple antennas (not shown in FIG. 1). In some embodiments, the number of antennas in the antenna arrays 111, 112 is larger than the number of antennas 115, 116 deployed in each of the user equipment 105, 106.

The base stations 101, 102 include transmitters 121, 122 for generating signals for transmission, as discussed in detail below. The signals generated by the transmitters 121, 122 may be provided to the antenna arrays 111, 112 for transmission over the air interface. The base stations 101, 102 also include receivers 123, 124 for receiving signals transmitted over the air interface, such as signals transmitted from user equipment 105, 106. User equipment 105, 106 include transmitters 125, 126 for transmitting signals over the air interface and receivers 127, 128 for receiving signals over the air interface. The transmitters 121, 122, 125, 126 and the receivers 123, 124, 127, 128 may be paired into transceiver pairs. For example, the transmitter 121 and the receiver 127 may form a transceiver pair that communicates over a downlink channel (or channels) 130. The transmitter 125 and the receiver 123 may also form a transceiver pair that communicates over an uplink channel (or channels) 135. The transmitter 122 and the receiver 128 form a transceiver pair that communicates over a downlink channel (or channels) 140 and the transmitter 126 and the receiver 124 form a transceiver pair that communicate over an uplink channel (or channels) 145.

Signals transmitted by the transceiver pairs to an intended receiver generate interference at the unintended receivers in all the other transceiver pairs. For example, downlink signals transmitted over the downlink channel 130 towards the receiver 127 may be received as interference by the receiver 128, as indicated by the arrow 150. For another example, downlink signals transmitted over the downlink channel 140 towards the receiver 128 may be received as interference by the receiver 127, as indicated by the arrow 155. Redundant antennas may therefore be used to mitigate interference at unintended receivers and enhance the signal at the intended receivers. In some embodiments, the number of redundant antennas is equal to the difference between the number of antennas used by a transmitter and the number of antennas at the intended receiver. For example, if the transmitter 121 transmits signals using four antennas in the antenna array 111 and the receiver 127 receives signals from a single antenna 115, there are three redundant antennas available to the transmitter 121 for interference mitigation and signal enhancement.

Some embodiments of transmitters 121, 122, 125, 126 may perform interference mitigation and/or signal enhancement by choosing an initial signaling technique, e.g., by choosing initial covariance matrices of the signals that are to be transmitted over the air interface. For example, the initial value of the covariance matrices may be set to zero, a multiple of the identity matrix, a random covariance matrix, or to other values. The initial value of the covariance matrices are constrained by the total power available for transmission over the air interface. The following discussion describes interference mitigation and signal enhancement performed by the transmitter 121 in the base station 101. However, other embodiments may be implemented in other transmitters.

The number of antennas (tᵢ) available to the transmitter 121 is larger than the number of antennas (rᵢ) available to the intended receiver 127 in the transceiver pair, e.g., for transmitter i, the relation tᵢ>rᵢ is satisfied. The transmitter 121 may perform a linear transformation to generate a first set of virtual antennas from the actual antennas, e.g., antennas 113 in the antenna array 111. In some embodiments, each virtual antenna is a weighted combination of one or more actual antennas 113. The transmitter 121 further divides the first set of virtual antennas into a first subset and a second subset of virtual antennas. The number of virtual antennas in the first subset is equal to the number of antennas (rᵢ) at the intended receiver 127, and the number of antennas in the second subset (i.e., the number of redundant antennas) is equal to the difference between the number of antennas (tᵢ) available to the transmitter 121 and the number of antennas (rᵢ) available to the intended receiver 127, tᵢ−rᵢ.

To mitigate interference at the intended receiver 127, the transmitter 121 generates a first signal for transmission from the first subset of the first set of virtual antennas signal towards all receivers, i.e., both the intended receiver 127 and the unintended receiver 128. For example, the first signal may be transmitted isotropically by the virtual antennas. The transmitter 121 also generates a second signal for transmission from the second subset of the first set of virtual antennas towards only the unintended receiver 128. For example, signals generated by the transmitter 121 may be weighted or precoded so that the second signal transmitted by the second subset of the first set of virtual antennas are directed towards only the unintended receiver, 128.

Signals generated by the transmitter 121 for transmission by the second subset of the first set of virtual antennas are typically a linear combination of a first portion that is correlated with the first signal and a second portion that is uncorrelated with the first signal. Some embodiments of the transmitter 121 modify the second signal so that the second signal carries no new information relative to the first signal. For example, the transmitter 121 may remove any portion of the second signal that is uncorrelated with the first signal. Consequently, the modified second signal is perfectly correlated with the first signal from the first subset of the first set of virtual antennas. Removing the uncorrelated portion of the second signal reduces interference at the unintended receiver 128. The uncorrelated portion of the second signal is therefore not transmitted and the portion of the transmission power of the base station 101 that would have been used to transmit the uncorrelated portion is saved and can be used for signal enhancement, as discussed below. Moreover, since only the uncorrelated portion of the second signal is removed, the signal received at the intended receiver 127 is not degraded.

The transmitter 121 may then use the transmission power saved by removing the uncorrelated portion of the second signal to enhance useful signals at the intended receiver 127. Some embodiments of the transmitter perform a second linear transformation to generate a second set of virtual antennas from the antenna array 121. The second linear transformation divides the second set of virtual antennas into a first subset and a second subset. Signals transmitted by the first subset of the second set of virtual antennas are received by the intended receiver 127 and the unintended receiver 128. Signals transmitted by the second subset of the second set of virtual antennas are only received by the intended receiver 127 and therefore can strengthen the useful signal at the intended receiver 127. For example, the transmitter 121 can remove a portion of the signals that are to be transmitted by the second subset of the second set of virtual antennas. The removed portion is uncorrelated with the signals that are to be transmitted by the first subset of the second set of virtual antennas. The power associated with the removed uncorrelated portion may be used to enhance the useful signal at the intended receiver 127.

The transmission power that has not been allocated for transmission of signals in the previous steps can be allocated to transmission of the signal directed towards the intended receiver 127. Some embodiments of the transmitter 121 may use a water filling algorithm to allocate the leftover transmission power. For example, the transmitter 121 may perform the water filling algorithm by treating both the interference and useful signal as noise. The water filling solution represents the covariance matrix of the additional signal to be sent from the second subset of the second set of virtual antennas. This additional signal strengthens the useful signal at the intended receiver 127. Moreover, since only the uncorrelated portion was used to enhance the useful signal and the corresponding extra signal was not received by any unintended receivers, the interference at the unintended receiver 128 remains the same.

Some embodiments of the transmitter 121 may iteratively perform interference mitigation and signal enhancement until a convergence criterion is reached. For example, the interference mitigation/signal enhancement algorithm may be iterated until the rate of improvement in a sum rate (or one or more individual transmission rates) falls below a threshold. Other embodiments may use other convergence criteria. Once the interference mitigation/signal enhancement algorithm is complete, e.g., once the covariance matrices for the transmitted signals have been determined, the transmitter 121 may transmit the signals using the antenna array 111. Each iteration reduces the interference generated at the unintended receiver 128 and so the interference detected at the unintended receiver 128 is weaker than the interference that would have been received using the initial covariance matrices before the iterative process is performed. The useful signal received by the intended receiver 127 may also be strengthened because the useful signal is enhanced in each round of iteration. Embodiments of the interference mitigation/signal enhancement algorithm are guaranteed to converge since the sum rate is increased in each round of iteration. Therefore, each individual rate is improved relative to the individual rates achieved by the initial signaling.

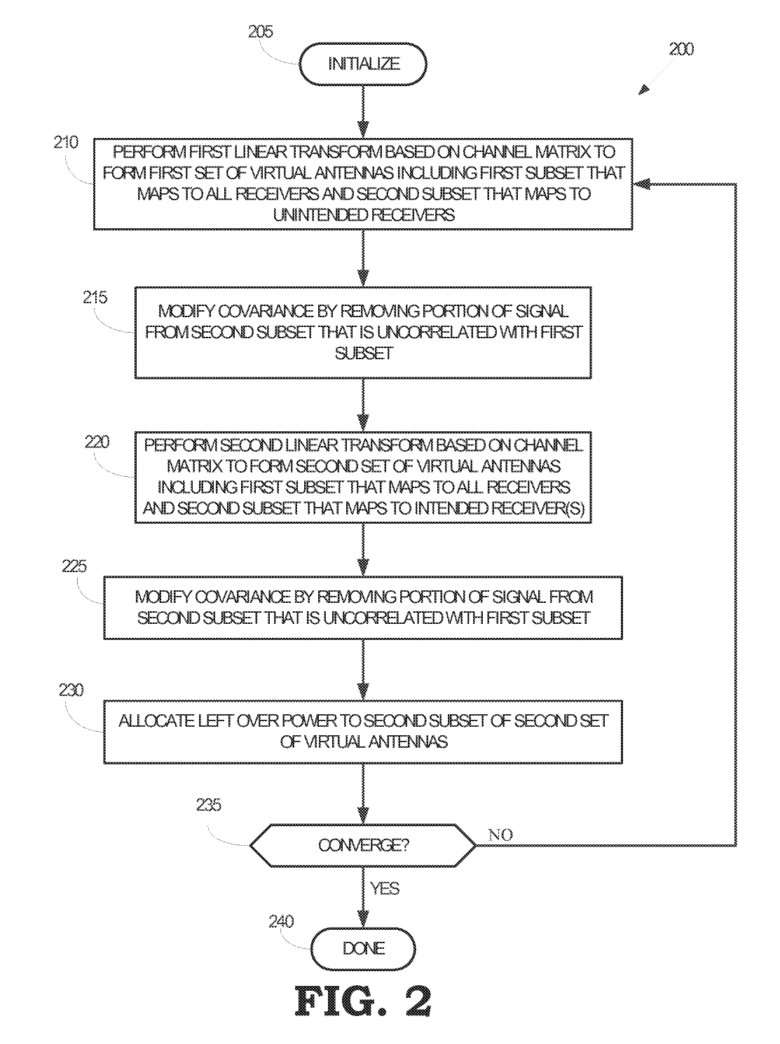

FIG. 2 is a flow diagram of a method 200 for performing interference mitigation and signal enhancement according to some embodiments. The method 200 may be implemented in some embodiments of a transmitter such as the transmitters 121, 122 shown in FIG. 1. At block 205, the transmitter initializes parameters including the channel matrix between the transmitter and receivers in the wireless communication system, the total power allocated for transmission from the transmitter, covariance matrices, and linear transformation matrices. For example, the received signals at receiver i may be represented as:

$$\begin{matrix}{y}_{i} = {\overline{H}}_{ii} {x}_{i} + {\sum }_{j = 1 , j \neq i}^{K} {\overline{H}}_{ji} {x}_{j} + {z}_{i} , & i = 1 , 2 , ⋯ K\end{matrix} \qquad ( 1 )$$

where xᵢ and xⱼ are the transmit Gaussian-coded signals from transmitter i and transmitter j, respectively. The channel matrix H̅ᵢⱼ can be defined for channels from transmitter i to receiver j and zᵢ is zero-mean complex Gaussian noise with identity covariance matrix. The power constraint for transmitter i is

trace(Sᵢ)≦P (2)

where trace(Sᵢ) denotes the trace of matrix Sᵢ, Pᵢ is the power available for transmission from transmitter i, and Sᵢ denotes the covariance matrix of xᵢ:

Sᵢ=Cov(xᵢ). (3)

The transmitter i obtains estimates of the elements of the channel matrix H̅ᵢⱼ and H̅ⱼᵢ, j=1, . . . K. Some embodiments of the transmitter i obtain the estimated values using feedback information from the corresponding receiver or other techniques. The estimates may be denoted as Hᵢⱼ and Hⱼᵢ respectively. A channel decomposition may then be performed to derive linear transform matrices that are used to generate virtual antennas, as discussed below. Some embodiments may perform a singular value decomposition of the channel matrix H̅ᵢⱼ to derive the first linear transform matrix. For example, the equation:

Hᵢᵢ=Uᵢ[Λᵢ0]Vᵢ^{H} (4)

denotes the singular value decomposition of matrix Hᵢᵢ, where Uᵢ and Vᵢ are both unitary matrices, Λᵢ is a rᵢ×rᵢ diagonal matrix with positive diagonal entries, and Vᵢ^{H} denotes the conjugate transpose of Vᵢ. The zero matrix has (tᵢ−rᵢ) columns. A second linear transform matrix can be generated using a QR decomposition of the channel matrix H̅ᵢⱼ. For example, the equation:

$$[ \begin{matrix}{H}_{i 1}^{H} & ⋯ & {H}_{i , i - 1}^{H} & {H}_{i , i + 1}^{H} & ⋯ & {H}_{iK}^{H}\end{matrix} ] = {Q}_{i} [ \begin{matrix}{\tilde{H}}_{i 1}^{H} & ⋯ & {\tilde{H}}_{i , i - 1}^{H} & {\tilde{H}}_{i , i + 1}^{H} & ⋯ & {\tilde{H}}_{iK}^{H} \\ 0 & ⋯ & 0 & 0 & ⋯ & 0\end{matrix} ] \qquad ( 5 )$$

denotes QR decomposition of the block matrix on the left-hand side, Qᵢ is a unitary matrix, and the block matrix on the right-hand side is an upper triangular matrix. The zero matrices have (tᵢ−r_{Fi}) rows where

$${r}_{Fi} = min \{ {t}_{i} , {\sum }_{j = 1 , j \neq i}^{K} {r}_{j} \} . \qquad ( 6 )$$

The initial value of the covariance matrix for the transmitted signals may be generated at block 205. Starting from i=1 to K, let

Sᵢ:=Sᵢ⁰ (7)

where the covariance matrix Sᵢ⁰ can be a zero matrix, an identity matrix I multiplied by Pᵢ/tᵢ, or any arbitrary Hermitian positive semi-definite matrix satisfying the power constraint.

At block 210, a first linear transform may be performed to form a first set of virtual antennas based on antennas such as the antennas 113 in the antenna array 111 shown in FIG. 1. The first set of virtual antennas includes a first subset that maps to all receivers so that signals transmitted by the first set of virtual antennas are directed towards intended receivers and unintended receivers. The first set of virtual antennas also includes a second subset that maps to unintended receivers so that signals transmitted by the second set of virtual antennas are directed only towards the unintended receivers and are not directed towards the intended receivers. For example, starting from i=1 to K, the first linear transform Vᵢ derived using the singular value decomposition may be used to compute Vᵢ^{H}SᵢVᵢ and write it into a block matrix form:

$$[ \begin{matrix}{S}_{i 1} & {A}_{i}^{H} \\ {A}_{i} & {S}_{i 2}\end{matrix} ] = {V}_{i}^{H} {S}_{i} {V}_{i} \qquad ( 8 )$$

where Sᵢ₁ is a rᵢ×rᵢ matrix. The first subset of the first set of virtual antennas corresponds to the first rᵢ virtual transmit antennas after the linear transformation Vᵢ^{H}xᵢ. The signal transmitted by the first subset (i.e., the first rᵢ entries of Vᵢ^{H}xᵢ) has covariance Sᵢ₁. The second subset of the first set of virtual antennas are the last (tᵢ−rᵢ) transmit antennas after the linear transformation Vᵢ^{H}xᵢ.

At block 215, the covariance of the transmitted signals is modified by removing a portion of a signal to be transmitted by the second subset. The removed portion is uncorrelated with signals to be transmitted by the first subset. For example, the covariance matrix Sᵢ defined in equation (8) may be updated as indicated in the following equation:

$${S}_{i} := {V}_{i} [ \begin{matrix}{S}_{i 1} & {A}_{i}^{H} \\ {A}_{i} & {A}_{i} {S}_{i 1}^{+} {A}_{i}^{H}\end{matrix} ] {V}_{i}^{H} \qquad ( 9 )$$

where Sᵢ₁⁺, denotes the pseudo-inverse of Sᵢ₁. The updated signal (i.e, the last (tᵢ−rᵢ) entries of Vᵢ^{H}xᵢ) has covariance AᵢSᵢ₁⁺Aᵢ^{H}, and has correlation Aᵢ with the signals from the first subset of the first set of virtual antennas, which implies that signals to be transmitted from the first and second subsets of the first set of virtual antennas are perfectly correlated.

At block 220, the transmitter performs a second linear transformation to form a second set of virtual antennas from the antennas associated with the transmitter. The second set of virtual antennas includes a first subset that maps to the intended and unintended receivers. The second subset only maps to the intended receivers so that signals transmitted from the second subset are directed to the intended receivers and are not directed to the unintended receivers. For example, the second linear transformation derived from the QR decomposition may be used to compute Qᵢ^{H}SᵢQᵢ and write it into a block matrix form

$$[ \begin{matrix}{\tilde{S}}_{i 1} & {\tilde{B}}_{i}^{H} \\ {\tilde{B}}_{i} & {\tilde{S}}_{i 2}\end{matrix} ] = {Q}_{i}^{H} {S}_{i} {Q}_{i} \qquad ( 10 )$$

where \tilde{S}ᵢ₁ is a r_{Fi}×r_{Fi} matrix. The first subset of the second set of virtual antennas correspond to the first r_{Fi} virtual transmit antennas after the second linear transformation Qᵢ^{H}xᵢ. The signal to be transmitted from the first subset (i.e., the first r_{Fi} entries of Qᵢ^{H}xᵢ) has covariance \tilde{S}ᵢ₁. The second subset of the second set of virtual antennas correspond to the last (tᵢ−r_{Fi}) antennas after the second linear transformation Qᵢ^{H}xᵢ.

At block 225, the covariance of the signal to be transmitted from the second subset of the second set of virtual antennas is modified by removing a portion of the signal from the second subset that is uncorrelated with signals transmitted from the first subset of the second set of virtual antennas. For example, the covariance matrix defined in equation (10) may be modified as:

$${S}_{io} = {Q}_{i} [ \begin{matrix}{\tilde{S}}_{i 1} & {\tilde{B}}_{i}^{H} \\ {\tilde{B}}_{i} & {B}_{i} {\tilde{S}}_{i 1}^{+} {B}_{i}^{H}\end{matrix} ] {Q}_{i}^{H} \qquad ( 11 )$$

Removing uncorrelated portions of the signals to be transmitted saves some of the transmission power of the transmitter. For example, the saved (and now available) portion (\tilde{P}ᵢ) of the transmission power may be represented as:

\tilde{P}ᵢ=Pᵢ−trace(Sᵢₒ) (12)

and the transformed channel matrices may be represented as:

[\tilde{H}ᵢᵢ₁Hᵢᵢ₂]=\tilde{H}ᵢᵢ=HᵢᵢQᵢ (13)

where \tilde{H}ᵢᵢ₁ has r_{Fi} columns and \tilde{H}ᵢᵢ₂ has (tᵢ−r_{Fi}) columns.

At block 230, the leftover portion (\tilde{P}ᵢ) of the transmission power can be allocated to the second subset of the second set of virtual antennas to enhance the signal received at the intended receiver. Some embodiments of the transmitter may use a water filling algorithm to allocate the leftover transmission power. For example, the transmitter may use a water filling algorithm to compute the optimal covariance matrix Wᵢ* that maximizes the following expression:

$${W}_{i}^{*} = {arg max}_{trace ( {W}_{i} ) \leq {\tilde{P}}_{i}} det ( I + {\tilde{H}}_{ii 2} {W}_{i} {{\tilde{H}}_{ii 2}^{H} ( I + {\tilde{H}}_{ii} {S}_{io} {\tilde{H}}_{ii}^{H} + {\sum }_{j = 1 , j \neq i}^{K} {H}_{ji} {S}_{j} {H}_{ji}^{H} )}^{- 1} ) \qquad ( 14 )$$

where det(•) denotes a determinant of a matrix and Wᵢ is a matrix parameter to be optimized. Embodiments of the matrix can be any positive semi-definite matrix as long as Tr(Wᵢ)<\tilde{P}ᵢ. The water filling solution given in equation (14) can then be used to allocate power by updating the covariance matrix Sᵢ as:

$${S}_{i} := {Q}_{i} [ \begin{matrix}{\tilde{S}}_{i 1} & {\tilde{B}}_{i}^{H} \\ {\tilde{B}}_{i} & {B}_{i} {\tilde{S}}_{i 1}^{+} {B}_{i}^{H} + {W}_{i}^{*}\end{matrix} ] {Q}_{i}^{H} . \qquad ( 15 )$$

After allocating the leftover power to the second subset of the second set of virtual antennas, the signal to be transmitted by the second subset of the second set of virtual antennas (i.e., the last (tᵢ−r_{Fi}) entries of Qᵢ^{H}xᵢ) has covariance Bᵢ\tilde{S}ᵢ₁⁺Bᵢ^{H}+Wᵢ*, and has correlation Bᵢ with the signal from the first subset of the second set of virtual antennas.

At decision block 235, the transmitter determines whether a convergence criterion has been satisfied. For example, the transistor may determine a rate of improvement in a sum rate or one or more individual transmission rates following block 230. As long as the rate is above a threshold that indicates a certain level of improvement in the sum rate or the individual transmission rates, the convergence criterion is not satisfied, and the process indicated in box 210, 215, 220, 225, 230 may be iterated using the modified value of the covariance matrix Sᵢ as the starting point for the next iteration. The transmitter may determine that the convergence criterion is satisfied if the rate of improvement is below the threshold, in which case the method 700 ends (at block 240). The transmitter may then use the final value of the covariance matrix Sᵢ as the covariance matrix of the transmit signal xᵢ.

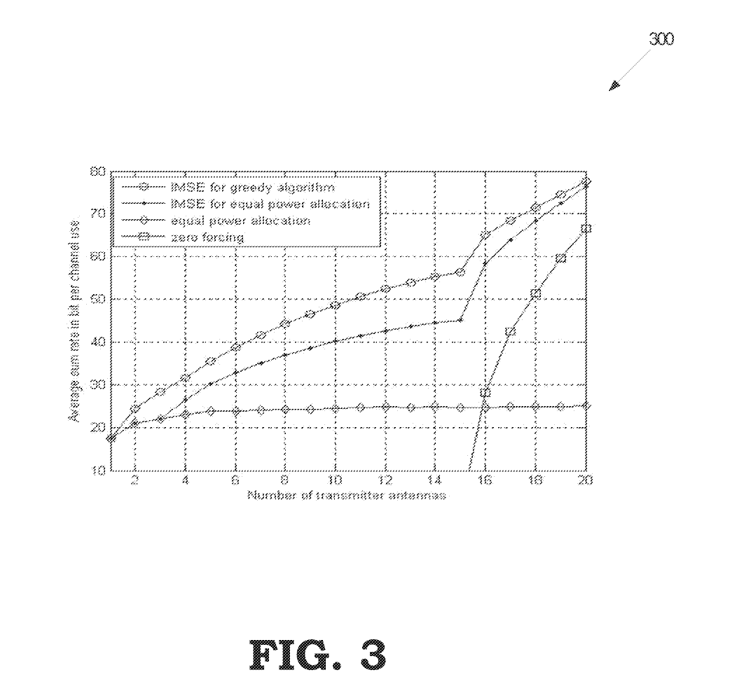

FIG. 3 is a plot 300 that illustrates the improvement in the average sum rate that can be achieved by interference mitigation and signal enhancement according to some embodiments. The horizontal axis indicates the number of transmitter antennas that are used to transmit the signal towards the intended receivers and the vertical axis indicates the average sum rate for signals decoded by the intended receivers (in bits per channel use). The results shown in FIG. 3 are generated using a simulation of a scenario with 6 transceiver pairs and each receiver has 3 antennas. The transmitters have the same number of antennas, which varies from 1 to 20 in the different simulation runs. The signal-to-noise ratio (SNR) in the system is given by SNR=10 dB and the interference link channel gain is 10 dB below the direct link channel gain. The average sum rates are taken after 100 channel realizations.

Embodiments of the interference mitigation and signal enhancement (IMSE) techniques described herein show significant improvement over conventional techniques such as equal power allocation and zero forcing. The average sum rate is shown for four cases: (1) the IMSE technique using an initial value of the covariance matrix obtained from a greedy algorithm, (2) the IMSE technique using an initial value of the covariance matrix obtained from equal power allocation, (3) equal power allocation, and (4) zero-forcing. The total number of receive antennas of the unintended receivers is 15 and consequently the zero forcing technique cannot be used for scenarios in which the number of transmitter antennas is in the range 1 to 15, as discussed herein. Both examples of the IMSE technique provide an average sum rate that is the same or larger than the average sum rate achieved by the equal power allocation approach. The rate improvement is a result of only interference mitigation. For numbers of antennas larger than 16, zero-forcing method starts to work. In this case, IMSE technique experiences a more rapid rate improvement which is a result of the iteration between interference mitigation and signal enhancement. Both examples of the IMSE technique achieve an average sum rate that exceeds the average sum rate achieved by zero-forcing by 15%˜260% depending on the number of antennas.

Embodiments of the IMSE techniques that utilize redundant antennas as described herein may therefore have a number of advantages over the conventional equal power allocation or zero forcing techniques. For example, the proposed interference mitigation using redundant antennas may reduce interference and improve transmission rate for multi-user multi-antenna channels, such as interference channels or uplink channels, by treating interference as noise. Embodiments of the IMSE techniques can significantly reduce interference generated by each transmitter to all other receivers and enhance the received useful signal strength. Embodiments of the IMSE techniques may be implemented with low computational complexity and high efficiency. The computation is based on formulas with closed-form expressions, and simulations have demonstrated that the scheme converges after only a few (usually less than 5) iterations. Compared to existing schemes such as zero-forcing, improvements ranging from 15%-260% can be achieved. Since the IMSE technique depends on the choice of initial values, a better initial value can bring even larger improvement of the rate.

In some embodiments, certain aspects of the techniques described above may implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)). The executable instructions stored on the non-transitory computer readable storage medium may be in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method comprising:
mitigating interference created at one or more unintended receivers by a first signal transmitted from a transmitter to an intended receiver and the unintended receivers by removing portions of a second signal that are uncorrelated with the first signal, wherein the second signal is directed towards the unintended receivers; and
enhancing a third signal at the intended receiver by allocating a portion of a transmission power associated with the removed portions of the second signal to the third signal.

2. The method of claim 1, wherein mitigating interference at the unintended receivers comprises generating a first linear transform based on a channel matrix associated with the transmitter and the intended receiver.

3. The method of claim 2, wherein mitigating interference at the unintended receivers comprises applying the first linear transform to derive a first set of virtual antennas from a plurality of antennas associated with the transmitter, wherein a first subset of the first set maps to the intended receiver and the unintended receivers, and wherein a second subset of the first set maps to the unintended receivers.

4. The method of claim 3, wherein the first signal is associated with the first subset of the first set, and wherein the second signal is associated with the second subset of the first set, and wherein mitigating interference at the unintended receivers comprises removing a portion of the second signal that is uncorrelated with the first signal.

5. The method of claim 4, wherein enhancing the third signal at the intended receiver comprises generating a second linear transform based on the channel matrix.

6. The method of claim 5, wherein enhancing the third signal at the intended receiver comprises applying the second linear transform to derive a second set of virtual antennas from the plurality of antennas, wherein a first subset of the second set maps to the intended receiver and the unintended receivers, and wherein a second subset of the second set maps to the intended receiver.

7. The method of claim 6, wherein enhancing the third signal at the intended receiver comprises removing a portion of a fourth signal associated with the second subset of the second set, wherein the portion is uncorrelated with a fifth signal associated with the first subset of the second set.

8. The method of claim 7, wherein enhancing the third signal at the intended receiver comprises allocating transmission power associated with the portion of the fourth signal to the second subset of the second set of virtual antennas.

9. The method of claim 8, wherein allocating the transmission power comprises allocating the transmission power using a water filling algorithm to allocate the transmission power associated with the portion of the fourth signal to the second subset of the second set of virtual antennas based on interference associated with the transmitter.

10. The method of claim 1, comprising iteratively mitigating interference and enhancing the third signal at the intended receiver until a convergence criterion is satisfied.

11. A transmitter to transmit a first signal to an intended receiver and one or more unintended receivers, mitigate interference created at the unintended receivers by the first signal transmitted by removing portions of a second signal that are uncorrelated with the first signal, wherein transmitter directs the second signal towards the unintended receivers, and enhance a third signal at the intended receiver by allocating a portion of a transmission power associated with the removed portions of the second signal to the third signal.

12. The transmitter of claim 11, wherein the transmitter generates a first linear transformation based on a channel matrix associated with the transmitter and the intended receiver, and wherein the transmitter generates a second linear transformation based on channel matrices associated with the intended receiver, the transmitter, and one or more other transmitters.

13. The transmitter of claim 12, wherein the transmitter applies the first linear transform to derive a first set of virtual antennas from a plurality of antennas associated with the transmitter, wherein a first subset of the first set maps to the intended receiver and the unintended receivers, and wherein a second subset of the first set maps to the unintended receivers.

14. The transmitter of claim 13, wherein the first signal is associated with the first subset of the first set, and wherein the second signal is associated with the second subset of the first set, and wherein the transmitter removes a portion of the second signal that is uncorrelated with the first signal.

15. The transmitter of claim 14, wherein the transmitter applies the second linear transform to derive a second set of virtual antennas from the plurality of antennas, wherein a first subset of the second set maps to the intended receiver and the unintended receivers, and wherein a second subset of the second set maps to the intended receiver.

16. The transmitter of claim 15, wherein the transmitter removes a portion of a fourth signal associated with the second subset of the second set, wherein the portion is uncorrelated with a fifth signal associated with the first subset of the second set.

17. The transmitter of claim 16, wherein the transmitter allocates transmission power associated with the portion of the fourth signal to the second subset of the second set of virtual antennas.

18. The transmitter of claim 17, wherein the transmitter allocates the transmission power using a water filling algorithm to allocate the transmission power associated with the portion of the fourth signal to the second subset of the second set of virtual antennas based on interference associated with the transmitter.

19. The transmitter of claim 11, wherein the transmitter iteratively mitigates interference and enhances the third signal at the intended receiver until a convergence criterion is satisfied.

20. A non-transitory computer readable medium embodying a set of executable instructions, the set of executable instructions to manipulate at least one processor to:
mitigate interference created at one or more unintended receivers by a first signal transmitted from a transmitter to an intended receiver and the unintended receivers by removing portions of a second signal that are uncorrelated with the first signal, wherein the second signal is directed towards the unintended receivers; and
enhance a third signal at the intended receiver by allocating a portion of a transmission power associated with the removed portions of the second signal to the third signal.
